(19) United States
(12) Patent Application Publication
(10) Pub. No.: US 2024/0356747 A1
(43) Pub. Date: Oct. 24, 2024

(54) SECURITY APPLICATION FOR AN IT DEVICE, AND CORRESPONDING SECURITY ARCHITECTURE

(71) Applicant: CYFERALL, Montigny-le-Bretonneux (FR)

(72) Inventor: Jean-Louis Olie, Viroflay (FR)

(73) Assignee: CYFERALL, Montigny-le-Bretonneux (FR)

(21) Appl. No.: 18/698,457

(22) PCT Filed: Oct. 10, 2022
(86) PCT No.: PCT/EP2022/078066

§ 371 Date: Apr. 4, 2024

(30) Foreign Application Priority Data
Oct. 8, 2021 (FR) FR2110521

(51) Int. Cl. H04L 9/14

(52) U.S. Cl. CPC H04L 9/14

(57) ABSTRACT

The present invention relates to a security system (100) for IT devices (150), the security system being suitable for:
allowing a security application (104) to define an enclave of the random access memory (RAM) which only the security application (104) can access, this enclave possibly being located within a larger protected area resulting from the implementation of a virtual machine capable of hosting third-party software that must co-operate with the secured services and the drivers of the information creation and retrieval peripherals; and
running this security application (104) on the physical machine or on the virtual machine, wherein the security application controls access to the enclave and uses it to store the plaintext data to be protected.

This invention relates to a security system for one or more IT devices, a security application, a security policy decision point, and a security architecture comprising the security application, the security policy decision point, and an encrypted data exchange routing server.

### PRIOR ART

The National Institute of Standards and Technology (NIST) has promoted a network architecture that it calls “Zero Trust.” The goal of zero trust is to provide industry guidance on how to configure a network architecture that can withstand unauthorized breaches and cyber-attacks. The notion of zero trust comes from the idea that, traditionally, users in a private network can be trusted because they have been authenticated, but in a zero trust model, even users who move within a private network are not considered “trusted entities” and are subject to the same checks as “outsiders.”

According to NIST Special Publication 800-207, “Zero-Trust Architecture,” one of the fundamental components of such an architecture is the “Policy Enforcement Point”, where access from the untrusted area to the trusted area is controlled according to strictly defined rules. When applying this architecture to a set of multiple IT devices that are remote from each other, each of which can send or receive encrypted data, this “Policy Enforcement Point” must be physically divided into multiple components: (i) multiple security policy enforcement points (SPEPs) in each of the IT devices, and (ii) a routing server (RS) managing the routing of encrypted information to the authenticated recipients. Another essential component of such an architecture is the security policy decision point (SPDP). It will comprise two sub-components, which will not necessarily be located on the same computer: (i) the security policy engine, which makes the decision to grant access to users, and (ii) the security policy administrator, which executes the security policy engine's decision via prompts sent to the SPEPs via the RS.

The present invention aims to remedy one or more of the disadvantages associated with the prior art.

### SUMMARY OF THE INVENTION

In accordance with the present inventions, a security application is provided for an IT device configured to: implement an enclave in a random access memory (RAM) of the IT device, the enclave being a secure area exclusively accessible to the security application; implement an initialization process for collecting user identification data; calculate, from the user identification data in communication with a remote security server, a master key for use in local encryption; implement a login process enabling the login identification data to be checked against the user identification data; and implement a management process for storing and processing at least the user identification data, the login identification data, the master key and the encryption keys exclusively within the enclave; in which security application the IT device receives a unique user number and a public key of an asymmetric encryption (ASYE) algorithm from the security server; and which security application is configured to provide the initialization process comprising generating a value h, wherein h=H(H(pwd)), pwd is a password received from the user, and H is a one-way hash function; encrypting the unique user number, a pseudorandom M key of a certain bit length, and the value h using the public key; and sending them to the security server.

In accordance with the present inventions, a security application is provided for an IT device, to facilitate encrypted communication, in which the security application is configured to communicate with a remote security policy decision point (SPDP) via a routing server (RS), the security application being configured under the control of the security policy decision point (SPDP) to: implement an enclave in a random access memory (RAM) of the IT device, the enclave being a secure area exclusively accessible to the security application; implement an initialization process for collecting user identification data; calculate, from the user identification data in communication with a remote security policy decision point, a master key for use in local encryption; implement a login process enabling the login identification data to be checked against the user identification data; and implement a management process for storing and processing at least the user identification data, the login identification data, the master key and the encryption keys exclusively within the enclave; in which security application, the IT device receives a unique user number and a public key of a first asymmetric encryption (ASYE) algorithm from the SPDP from the remote routing server (RS); and which security application is configured to provide the initialization process comprising generating a value h, wherein h=H(H(pwd)), pwd is a password received from the user, and H is a one-way hash function; encrypting the unique user number, a pseudorandom M key of a certain bit length, and the value h using the public key; and sending them to the SPDP via the RS.

According to one feature, the unique user number, the pseudorandom M key of a certain bit length, and the value h are concatenated prior to encryption using the public key.

Advantageously, the security application is configured to receive encrypted server initialization data from the SPDP server, and to decrypt the server initialization data by means of the encryption using the (M) key, wherein the server initialization data comprises a first secret value (s).

The security application is also configured to calculate the master key based on the first secret value (s), and the hashed version of the password H (pwd) wherein H is the one-way hash function.

More specifically, the master key is calculated according to H(s\hat{ }H(pwd)), wherein H is the one-way hash function, s is the first secret value, and \hat{ } is an XOR operation.

According to one feature, a control value C is calculated according to H(s\hat{ }H(s\hat{ }H(pwd))) and stored on a local bulk memory for subsequent reuse, wherein H is the one-way hash function, s is the first secret value, and \hat{ } is an XOR operation.

The security application is also configured to use the master key to encrypt one or more of the confidential data, an encryption key of a data encryption (DE) algorithm, for storage on a bulk memory.

The security application's login process is further configured to check the user's identity whenever there is a new login: receive a login password (Igpwd) from the user; calculate a hash function (H) of the login password, (Igpwd), H(Igpwd), then calculate a value (Igh) from a hash function of the result, so that Igh=H(H(Igpwd)); obtain a pseudorandom value (D), of a certain bit length; calculate a value (S), wherein S=H(M\hat{ }Igh); encrypt the unique user number and the D, M, and S values with the public key of the asymmetric encryption (ASYE) algorithm of the SPDP; and send the encrypted data to the security policy decision point (SPDP) as a login request, via the routing server (RS).

According to one feature, the unique user number and the D, M and S values are concatenated prior to encryption.

Advantageously, the security system is configured to make it possible, on receipt of the packet in response to a login request, to: check that this response packet originates from the security policy decision point (SPDP) by checking that the decryption of a second part of the packet using its private key of the first asymmetric encryption (ASYE) algorithm returns the D value; decrypt the first part of the response packet with the symmetric algorithm and the M key, in order to obtain the first secret value (s); recalculate the master key as equal to H(s\hat{ }H(Igpwd)); check that H(s\hat{ }H(s\hat{ }H(Igpwd))) is equal to the control value C stored during initialization; authorize use of the IT device's secure services if they originate from the security policy decision point (SPDP) and if the control value has actually been retrieved.

It is also configured to implement the data encryption (DE) algorithm. The security application is further configured to use two asymmetric encryption algorithms, a first algorithm (ASYE) to encrypt one or more of the data (DE) algorithm and initialization data keys, and a second algorithm (SASY) to sign the encryptions of these keys or of these data.

According to one feature, the security application is configured to use two key pair initialization algorithms, a third key pair initialization (KIN) algorithm associated with the first algorithm (ASYE) and a fourth key pair initialization (SIN) algorithm associated with the second algorithm (SASY).

Advantageously, the third and fourth algorithms (KIN; SIN) can be broken down into two parts, (KIN1, KIN2) for the third algorithm, (SIN1, SIN2) for the fourth algorithm.

Advantageously, the security system comprises, in response to the reception of the encrypted server initialization data from the SPDP server, the generation of two public-private key pairs of the asymmetric encryption algorithms (ASYE; SASY) using a second secret value (t), unknown to the SPDP with the encrypted server initialization data as input to the key pair initialization algorithms (KIN; SIN); or the generation of two public-private key pairs of the asymmetric encryption algorithms (ASYE; SASY) using the second secret value (t), as input if the encrypted server initialization data is empty.

The security application is also configured to send the two public keys of the asymmetric encryption algorithms (ASYE; SASY) to the routing server (RS). According to one feature, the master key is confined within the enclave.

The security application is further configured to implement a security policy enforcement point.

Advantageously, the security system is configured to be implemented in the enclave.

In accordance with the present inventions, a security architecture is provided comprising an IT device hosting the security application as described above, the remote security policy decision point (SPDP) server and the remote routing server (RS).

According to one feature, when an initialization request is received from a security application, the SPDP creates the first secret value (s), and stores it together with the value received for (h) and the unique user number.

The SPDP is further configured to: encrypt the initialization data concatenated with the secret value (s) by means of symmetric encryption using the M key; and send the encrypted result to the requesting security application via the routing server (RS).

The SPDP is also configured to: create initialization data that is empty if the key pair initialization algorithms (KIN; SIN) are not broken down into two parts, or include the output data of the algorithms (KIN1; SIN1) if they are broken down into two parts.

The security policy decision point (SPDP) is further configured so that when it receives the login request, it performs the following operations: decrypt the login request using its private asymmetric encryption (ASYE) algorithm key; check the unique user number; if the unique user number is valid, check that the received S value is equal to S=H(M\hat{ }h); and if S is confirmed, encrypt the first secret value (s) by symmetric encryption using the (M) key, concatenate it with the result of the encryption of (D) with the asymmetric encryption (ASYE) algorithm using the public key of the security application originating the login request; and send the concatenation to the security application via the routing server (RS).

According to one feature, the SPDP point is configured to send, via the routing server (RS), an empty value if one of the checks has failed.

The remote SPDP is also configured to perform the functions of a security policy decision point, comprising a security policy engine and a security policy administrator.

The remote routing server (RS) is further configured to carry out routing operations by keeping the encrypted data available to recipients for a certain period of time, keeping the public keys of the asymmetric encryption (ASYE; SASY) algorithms of the security policy decision point (SPDP) and of the initialized security applications available to any security application or to the security policy decision point (SPDP) which may require them, and to act under the control of the security policy decision point (SPDP) which can prohibit it from routing certain exchanges pursuant to the security policy.

In accordance with the present inventions, computer-implemented instructions are provided herein which, when executed by a processor, prompt the processor to provide the security application.

Within the scope of this application, it is expressly provided that the various aspects, embodiments, examples and variants disclosed in the preceding paragraphs, in the claims and/or in the following description and drawings, and in particular the individual features thereof, can be taken alone or in any combination. This means that all embodiments and/or features of any embodiment can be combined in any way and/or combination, unless these features are incompatible. The applicant reserves the right to amend any claim originally filed or to file any new claim accordingly, including the right to amend any claim originally filed to depend on and/or incorporate any feature of any other claim even though it was not originally claimed in this manner.

### BRIEF DESCRIPTION OF THE FIGURES

Various embodiments of the invention are described below with reference to the attached drawings, in which:

FIG. 1(a) is a block diagram of an exemplary security system according to the invention;

FIG. 1(b) is a block diagram of an exemplary IT device operating a security system according to the invention;

FIG. 1(c) is a block diagram of another exemplary IT device operating a security system according to the invention;

FIG. 1(d) is a block diagram of another exemplary IT device operating a security system according to the invention;

FIG. 2(a) is a block diagram of an exemplary security architecture according to the invention;

FIG. 2(b) is a block diagram of another exemplary security architecture according to the invention;

FIG. 3 is a block diagram illustrating the security architecture according to the invention.

### DETAILED DESCRIPTION

The security application covered by the invention gives the user of the IT device access to a range of secure services of all kinds, such as, for example, but not limited to, messaging, text messaging, telephone services, videoconferencing, collaborative document preparation, etc. Each of these secure services requires the exchange of encrypted data between a sending IT device, where the information is created, and a receiving device, where the information is retrieved. Data encryption also implies the provision of encryption keys. The security application is therefore equipped with an initialization process for providing these keys and, in accordance with the principles of the “Zero-Trust” architecture, this initialization is carried out under the control of a security policy decision point, remote from the IT device in which the security application is implemented. Moreover, this application must be equipped with a login process which, after initialization, gives the user of the IT device access to secure services if this user is recognized by the input of a password or by any biometric means connected to the IT device, these recognition elements also having been input for the first time during the initialization process. The two important aspects of the invention are, on the one hand, the fact that data encryption and decryption operations are carried out in a secure area of the IT device, inaccessible to any processes other than the secure application that might run on this IT device, as soon as the information is created for encryption and just before its retrieval for decryption, and, on the other hand, the fact that user recognition elements never leave the secure area and that these elements are used as the basis for calculating a master key, as part of a collaborative process with a remote security policy decision point, carried out for the first time at initialization and then in a consistent manner at each login, this master key being the unique means of accessing the data encryption keys and this master key never leaving the secure area, either. Thus, neither complete knowledge of the security application code nor its modification in any way whatsoever can make it possible to bypass the access control to secure services. Only when the correct password is input, or biometric recognition is carried out as required, can the master key be calculated correctly and confidential information encrypted/decrypted.

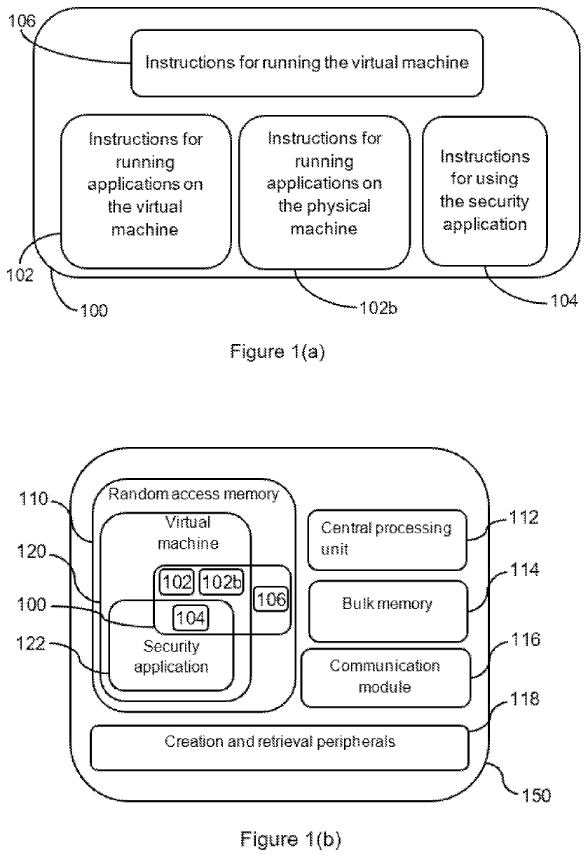

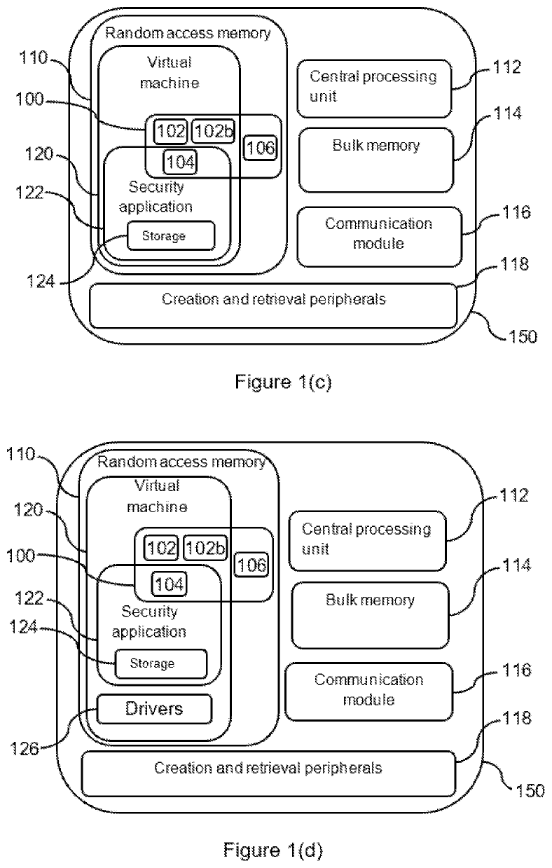

Referring to FIG. 1(a), a block diagram of a security system is shown, generally indicated by reference number 100, for an IT device according to the present invention. The security system 100 is designed to implement a virtual machine in the random access memory (RAM) of the IT device so that part of the RAM is allocated to the virtual machine, in which the allocated part of the RAM defines a secure area. The security system 100 comprises instructions for implementing the virtual machine, instructions for implementing the applications in the virtual machine 102 and instructions for operating the security application 104. In this variant comprising the implementation of a virtual machine, the instructions for implementing the applications in the physical machine, 102b, are not taken into account in the security system 100. Instructions for implementing the applications in the virtual machine 102 include instructions for implementing the applications running on this virtual machine in RAM so that part of the RAM is in turn allocated to these applications, in which the allocated part of the RAM in turn defines a secure area for each of these applications. These 102 instructions are an integral part of the virtual machine's operating system. The security system is further designed to run a security application on the virtual machine, in which the security application controls access to the secure area assigned to it by the virtual machine and which will be referred to as an enclave in the description of the invention. The operating instructions for the security application 104 include instructions for running the security application on the virtual machine. The security application is designed to check that any data entering or leaving the secure area is encrypted and, if necessary, signed in a predetermined way.

In a variant of the security system that does not implement a virtual machine, the instructions for implementing the virtual machine in RAM (106) are omitted from the security system 100, which then comprises only the instructions for using the applications in the physical machine (102b), which are an integral part of the operating system of this physical machine, and the instructions for operating the security application 104. In this variant, the enclave is the secure area of the RAM allocated by the physical machine to the security application.

Referring now to FIG. 1(b), a block diagram is shown of an IT device 150 implementing an exemplary security system according to the invention, such as the security system 100 shown in FIG. 1(a). The IT device 150 comprises a random access memory (RAM) module 110, a central processing unit (CPU) 112, a bulk memory 114, a communication module 116 and information creation and retrieval peripherals 118. The person skilled in the art will understand that the bulk memory 114 can comprise a single device or a plurality of suitable memory devices, and that similar considerations apply to other components where appropriate. Inside the RAM 110, the security system 100 implements a virtual machine 120, in which the security application 122 of the security system 100 runs. In a variant of the security system that implements the virtual machine, the security system 100 comprises the modules 102, 104 and 106. In a variant of the security system that does not implement the virtual machine, the security system 100 comprises only modules 102b and 104, and module 120 is not included in the IT device 150. The person skilled in the art will understand that the IT device 150 may comprise additional and similar modules not represented herein. It will be understood that the relative sizes of the blocks used to illustrate the modules in the block diagram in FIG. 1(b) are merely for illustrative purposes and are not representative of the relative sizes or scale of the components or features of these modules.

In this way, if the virtual machine 120 is implemented, it creates a secure area with the IT device that can be considered a trusted area, and in which the boundary of the virtual machine represents the boundary between the trusted area and the untrusted area. In a variant of the security system that does not implement the virtual memory, the boundary of the trusted area is reduced to the boundary of the security application 122, and the enclave is the only secure area for plaintext data processing. In the secure area, data can be processed in plaintext and encrypted before leaving the secure area to be stored, for example on the bulk memory 114, or sent to another IT device via the communication module 116. This means that data within the secure area is secure, even if it is in plaintext.

As the security application controls access to the data and resources in the secure area, it can be considered to function as an SPEP for the zero-trust model. The security application is designed to check that any data entering or leaving the secure area is encrypted and signed in a predetermined way. Encryption can be symmetric encryption, or asymmetric encryption can also be used, depending on the nature of the data to be protected. Data signing can use public key signing algorithms.

The fundamental design of the CPU 112 of the IT device ensures that the RAM allocated to the virtual machine (or to the security application if virtual memory is not implemented) is protected against any intrusion by other processes into the untrusted memory area, such as bulk memory or remaining RAM. In this way, undesirable or harmful processes such as malware attacking the IT device 150 cannot gain access to the virtual machine if implemented, nor a fortiori to the security application enclave.

Referring to FIG. 1(c), another exemplary IT device 150 is shown, in which the security system 100 has allocated a subportion 124 of RAM in the RAM allocated to the virtual machine (or in the overall RAM if the virtual machine is not implemented) for storing sensitive data by the security application 122. The subportion 124 can be used for storing unencrypted data before encryption or after decryption. The subportion 124 can be used to store encryption keys. The subportion 124 can be designated as an enclave in the security application 122. In a variant of the security system in which the virtual machine is not implemented, such as in FIG. 1(b), the security system 100 comprises only modules 102b and 104, and module 120 is not part of the IT device 150.

Referring to FIG. 1(d), another exemplary IT device 150 is shown, in which the virtual machine 120, if implemented, comprises drivers 126 for peripherals used for data input and retrieval. Thus, the creation of information, using peripherals 118 such as a keyboard, a microphone or a camera, and its digitization before encryption, then its decryption, conversion into analog form and restitution on peripherals such as screens, loudspeakers or printers, can be carried out in the secure area defined by the virtual machine. This means that data is not processed in plaintext outside the virtual machine. The creation and retrieval of unencrypted data is carried out within the virtual machine directly between the appropriate hardware device and the corresponding driver. The virtual machine 120 also provides a secure environment for running third-party software if the unencrypted information in raw form requires post-creation or pre-retrieval processing, such as desktop software applications, image and/or sound processing or business-specific applications. In a variant of the security system in which the virtual machine is not implemented, such as in FIGS. 1(b) and 1(c), the security system 100 comprises only modules 102b and 104, and module 120 is not part of the IT device 150. The areas of the RAM allocated to drivers and third-party software are in this case outside the trusted area, and the user will have to ensure that they are safe to use outside the scope of the invention.

The security application is designed to generate encryption keys based on the data received from the remote SPDP. The key generation process involves a master key and user password. The master key and password are stored and confined within the subportion of the RAM 124.

In all computers, RAM is very securely protected, and the allocation of RAM tranches to computer processes is controlled by the hardware's central processing unit, at the request of the operating system. To protect information from creation to retrieval, it is necessary to consider where to carry out encryption and decryption operations. By controlling access to the enclave for encryption and decryption operations via a hardware device, the central processing unit, which cannot be modified by malicious software, the encryption/decryption area is protected against the intrusion of such malicious software, and this is also true if the virtual machine is not implemented in the security system. The path from hardware capture devices (keyboard, microphone, camera) to the RAM and from this RAM to hardware retrieval devices (screen, speakers/headsets, printers) runs through software layers in the operating system, such as drivers. Like all other software layers, they can be infected with malware. Therefore, to ensure strong information protection, these software layers must be protected against infection. This can be achieved by virtualizing the entire operating system, in which case the entire virtual machine (including the operating system) will reside in the RAM and can be loaded from a malware-immunized, read-only memory medium. In contrast, if the virtual machine is not implemented, these drivers remain vulnerable to attacks from malware that could be present in the IT device 150. In this case, a technical analysis of these drivers must be conducted to determine their vulnerability. The use of the variant in which a virtual machine is implemented is therefore only necessary in cases in which third-party software or peripheral drivers, whose security functions are unknown or are deemed untrusted, should be used. In such cases, the virtual machine, by encompassing both the secure application and the third-party software and drivers, provides the secure framework for running the entire system.

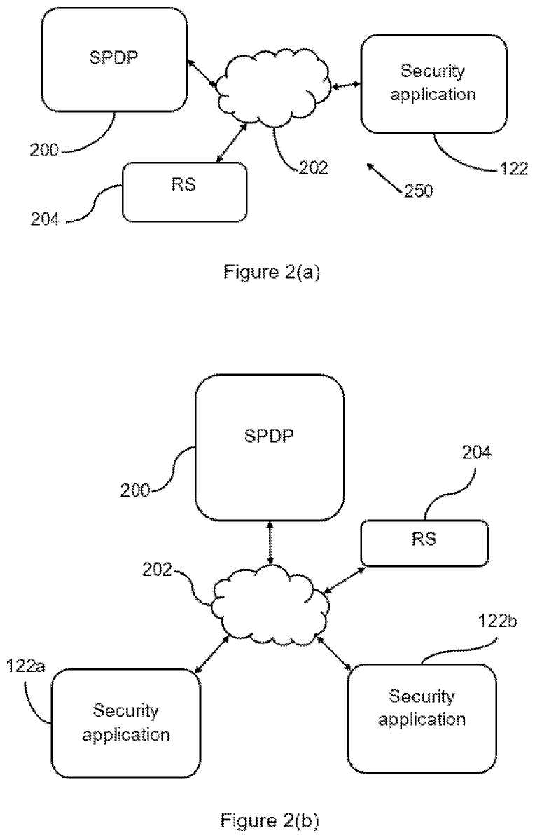

Referring now to FIG. 2(a), an exemplary security architecture is shown, generally indicated by the reference number 250. The security architecture 250 comprises a security application, such as the security application 122 described herein in relation to FIGS. 1(a) to (d), an SPDP 200 remote from the security application and a routing server RS 204. All encrypted data exchanged between the security application 122 and the SPDP 200 may be routed via the RS 204, which stores it for the appropriate period and keeps it available to the recipient, the SPDP or the security application. The SPDP 200 and the security application 122 can communicate with the RS 204 via a communication network 202 such as the Internet. Thus, only the RS 204 knows the IP addresses used by the SPDP 200 and the security application 122. Similarly, the security application only knows the RS address and does not have access to the addresses of the other IT devices.

FIG. 2(b) shows another network comprising the SPDP 200, a first security application 122a, a second security application 122b and the routing server RS 204. The person skilled in the art will understand that such a network can comprise additional IT devices implementing the security system of the invention. Each security application 122a, 122n can generate content, encrypt this content, store or send this encrypted content, receive encrypted content from another IT device implementing the security system, decrypt the received content and restitute the content. The remote SPDP 200 can comprise a security policy engine and a security policy administrator, and remotely authorize or prohibit exchanges between security applications 122a, 122n by issuing appropriate commands to the RS 204 in application of the security policy.

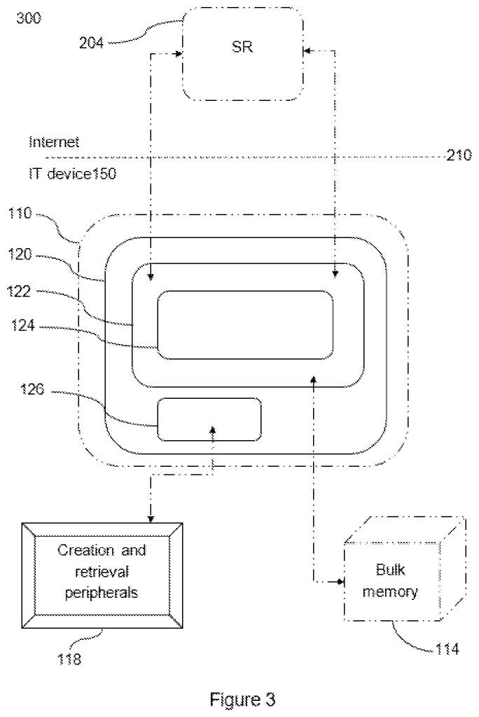

FIG. 3 shows another exemplary security architecture of the present invention, generally indicated by the reference number 300. The areas or paths denoted by a solid line in FIG. 3 indicate the secure area, wherein data can be processed in plaintext, meaning unencrypted. Areas or paths denoted by a dotted line indicate areas where data is in an encrypted form. A dotted line 210 denotes the dividing line between an IT device or a IT device 150 and the Internet 202. Shown here is a routing server 204 as described elsewhere in this document. The RAM module 110 of the IT device 150 comprises the virtual machine 120, which itself comprises the security application 122, if this virtual machine is implemented. The security application comprises the enclave 124. The peripheral devices 118 are in communication with the drivers 126 located in the virtual machine 120, if this virtual machine is implemented and a bulk memory 114 in communication with the security application 122. The security application 122 can communicate with the routing server 204.

The encryption of data sent between users of the security system can be based on an encryption algorithm, such as the One-Time Pad (OTP) symmetric encryption chosen for the security system and hereafter referred to as data encryption (DE). This algorithm can also be used to locally encrypt data and other confidential keys that need to be stored on the bulk memory of the IT device in question. The key used for these local operations is not shared with anyone else and is referred to as the master key.

Aspects of the present disclosure provide RAM-based content protection from creation to retrieval in an IT device. On the original IT device, content is created using an IT device peripheral such as a keyboard, microphone or camera. The content is digitized and sent to the RAM by the peripheral device driver, which is controlled by the operating system (OS). If the virtual machine is implemented, the drivers and the operating system itself run in the invention's virtual machine in the assigned part of the RAM. Content is transferred by the security application from the driver RAM to the enclave, where it is encrypted by this security application according to the chosen DE algorithm with a key that has been shared with the recipient beforehand.

Then, the encrypted content exits the IT device. The encrypted content is sent via the Internet to the RS 204. Based on rules defined and administered by the SPDP 200, the RS 204 ensures the routing of encrypted content, keeping it available to the recipient's IT device for a predefined period of time. Within this time period, the recipient can retrieve the encrypted content sent to him via the Internet 202.

On the recipient's IT device, the security application, which runs in a virtual machine in the RAM of the recipient's IT device, decrypts the content encrypted by the DE algorithm using the key shared with the sender. The content is converted to analog from the RAM by a driver of the appropriate peripheral device in which the driver is located in the virtual machine and is operated by the operating system of the virtual machine of the recipient's IT device, if the virtual machine is implemented. The content is then restituted by the appropriate peripheral, such as a screen, printer or loudspeaker on the recipient's IT device. In this way, the content is protected at all times, from generation to restitution. As long as the content is in plaintext, meaning before encryption or after decryption, it is in the enclave in the RAM, and when it is not in the enclave, it is encrypted.

To enable the initialization and mutual authentication of the users of the secure system, two asymmetric encryption algorithms, for example capable of withstanding attacks from quantum computers, can be chosen, the first (ASYE) to ensure the asymmetric encryption of the keys of the DE algorithm, the second (SASY) for the signature calculation enabling authentication in the DE key exchanges. For each of these two algorithms, a key pair initialization (public key, private key) algorithm can also be defined. These initialization algorithms are referred to as KIN for DE key encryption and SIN for signature. In a variant embodiment of the invention, the two algorithms, KIN and SIN, are themselves broken down into two parts, (KIN1, KIN2) and (SIN1, SIN2), respectively. This breakdown can be based on the following rules:
The pairs (public key, private key) are the output of KIN2, respectively SIN2;
Part 2, KIN2, respectively SIN2, can only be run with, as input data, the output data of KIN1, respectively SIN1, and additional data known only to the process running this part 2;
Knowing the output data of part 1, KIN1, respectively SIN1, is by no means sufficient to determine the pair (public key, private key) if the additional data remain unknown;

The direct consequence of applying these rules is that only the process running part 2 has access to the two private keys, but this process can only run in conjunction with the process running part 1. The SPDP can have two pairs (public key, private key) for the KIN and SIN algorithms. The two corresponding private keys are then only known to the SPDP.

Aspects of the present disclosure provide the description of two processes enabling the key pairs of the ASYE and SASY algorithms to be provided, with the initialization process of a security application and the verification of the rights to use the services of the security system at each login request from a security application, along with the login process. Within the scope of the security system disclosed in the invention, the two processes can meet the following requirements:
The private keys of the ASYE and SASY processes must only be known by the security applications that created them, to the exclusion of all other applications and of the SPDP;
The keys of the DE process must only be known by the security applications that decided to share them to enable the exchange of confidential data between these applications, to the exclusion of any other application that was not invited to share and of the SPDP;
The initialization process for a security application must enable the key pairs of the ASYE and SASY algorithms to be provided, even though the security application initially knows only the public keys of the ASYE and SASY algorithms of the SPDP and has no other encryption keys;
The initialization and login processes must be processes that are shared with the SPDP to prevent the security application from carrying out encryption operations outside the scope of use of the security system's services, as a means of cryptography, for example for malicious or criminal purposes.

In this disclosure, meeting these requirements depends on each security application creating a master key that is never stored anywhere other than in the secure application's enclave and that is the result of a collaborative calculation with the SPDP, first as part of the initialization process and then in a consistent manner for each new login.

For each of the security system's users, a master key is created through a collaborative IT process with the SPDP. In one example, the master key is 512 bits long. This master key is the underlying key that establishes the user's local DE encryption and ensures the security of the information and the security of the other keys stored in the bulk memory. This key is not shared with any other application or with the SPDP, and only the security application that has this key can decrypt data encrypted with it. To ensure that this master key never leaves the RAM and cannot be known by anyone, including the user himself, the master key is the result of a collaborative calculation between the security server and the IT device, with, as an input to this calculation, a password that is entered at the first login and then at each login, or that is the product of any user identification device that may be connected to the IT device, for example a biometric identification device.

To initialize the secure application of an IT device that wants to use the secure system's service, this IT device asks the RS for a unique user number and the SPDP public keys for the ASYE and SASY algorithms. This unique user number can be called a license number. These elements can be in plaintext in the transfer between the RS and the secure application originating the request, and this secure application can store these elements on the bulk memory without any particular protection for subsequent reuse.

During initialization, for example after receiving the unique user number, the user is prompted to choose a password, so that the security application receives the password, pwd, or identification data that can be condensed into a unique piece of data pwd, then applies a one-way hash function, H, to it, and stores the result of the hash, H(pwd), in the enclave 124.

The security application sends an encrypted version of each of the following to the remote SPDP via the RS: a pseudorandom key, M, of a certain bit length; the unique user number; and a value h which is the hashed version of the hashed password, (i.e. h=H(H(pwd))). The encrypted versions of these elements are obtained using the public encryption key of the remote SPDP's ASYE algorithm.

For the SPDP initialization process, when the SPDP receives the above encrypted elements, it decrypts them with its private key from the ASYE algorithm, creates a secret value s, and stores it together with the value received for h and the unique user number in its database for subsequent login authorizations. Next, the SPDP creates initialization data. In a variant in which the KIN and SIN algorithms are not broken down into two parts, this initialization data remains empty. In a variant in which these algorithms are broken down into two parts, the initialization data is the output data from parts 1 of the two algorithms, KIN1 and SIN1. The SPDP encrypts the initialization data concatenated to the secret value s using symmetric encryption with the M key, then sends the encrypted data to the security application originating the initialization request, via the RS.

When it receives the encrypted initialization data, the security application that initiated the initialization request decrypts the initialization data and the secret value s using the M key. If the initialization data is empty, the security application generates the two key pairs (public key, private key) by running the KIN and SIN algorithms based on a secret value t that is known only to this security application. If this is not the case, the security application generates the two pairs (public key, private key) by running the parts 2 of KIN2 and SIN2 with, as input, the initialization data received from the SPDP and a secret value t known only to this security application. In both variants, the private keys remain unknown to the security server. In the two-part variant, the pairs (public key, private key) can only be calculated by the security application in conjunction with the SPDP. The two public keys are sent to the RS to be made available to any other user or to the SPDP for subsequent authentication.

The security application calculates the master key based on the secret value s and on the hashed version of the password H(pwd). The master key is calculated according to H(s\hat{ }H(pwd)) and a check control C=H(s\hat{ }H(s\hat{ }H(pwd))) can be stored on a bulk memory for subsequent validation of login requests from the IT device in question, wherein H is the one-way hash function, s is the secret value shared with the SPDP, and \hat{ } is an XOR operation. This master key is not stored anywhere and will have to be recalculated accordingly each time the IT device in question logs in. The security application can then use the master key to subsequently encrypt confidential data local to the IT device in question, encryption keys from the DE algorithm shared with other users and its two private keys produced by KIN and SIN or KIN2 and SIN2, all of which can then be stored securely in encrypted form on the bulk memory. Access to confidential data and keys is thus rendered impossible if the master key is calculated incorrectly.

When two security applications on two different IT devices have completed their initialization, they may decide to exchange confidential data with each other. To this end, they can start by exchanging their public keys for the ASYE and SASY algorithms, then one of the two applications can construct a key for the DE algorithm as a pseudorandom number. After encryption and signature using the ASYE and SASY algorithms, this key can be sent to the other security application. This key can then be used to subsequently encrypt and decrypt all confidential data exchanged in encrypted form between the two security applications. All of these exchanges between security applications are routed through the RS, which ensures the appropriate routing and checks with the SPDP that both security applications have been correctly initialized as part of the security system.

Once the initialization procedure is complete, the security application can allow a user to log in again by checking the user's identity and rights to use the service. This can be done by receiving a login password, Igpwd, from the user or identification data that can be condensed into a single piece of data Igpwd and calculating a hash function, H, of Igpwd, H(Igpwd). Next, an Igh value can be calculated from a hash function of the result, so that Igh=H(H(Igpwd)). Next, the security application obtains a pseudorandom value D, of a certain bit length, and calculates a value S, wherein S=H(M\hat{ }Igh). The security application concatenates the unique user number and the D, M and S values, encrypts the concatenation with the SPDP's public key and sends the encrypted concatenation to the SPDP as a login request.

Upon receiving the login request, the SPDP decrypts the login request using its private key, checks the unique user number, and finds the s and h values corresponding to that user number and stored in its database during initialization. If the unique user number is confirmed, the SPDP checks that the received value S corresponds to the equality S=H(M\hat{ }h), in order to check S. If S is confirmed, the security server encrypts the secret value s with a symmetric encryption using the M key, concatenates this encrypted value with the result of the encryption of D with the public key of the ASYE algorithm of the application initiating the login request, and sends the concatenation back to this security application. If all checks fail, the returned encrypted value can be blank. This security application can then check that the response has actually come from the SPDP by checking that the decryption of the second part of the concatenation received with its private key from the ASYE algorithm enables D to be found, and then decrypting the first part of the concatenation using the M key, the result of this operation being s, recalculating the master key as equal to H(s\hat{ }H(Igpwd)) and checking that the value H(s\hat{ }H(s\hat{ }H(Igpwd))) corresponds to the value of the control C stored in the bulk memory at the end of initialization. If the encrypted value returned is not empty, if the concatenation received is confirmed as coming from the SPDP, and if this correspondence is assured, the security application can authorize the use of the secure services of the IT device in question.

Advantageously, in a security architecture thus equipped with initialization and login processes as described, authorization to access secure services cannot be forced by a change in the code of the security application which would, for example, make the check of the control C always positive. This control is only an indication to the user that the password is correct or not. If the password is incorrect, the calculated value of the master key is necessarily erroneous and the encryption keys of the DE algorithm and the private keys of the ASYE and SASY algorithms cannot be decrypted, making it impossible to use the secure services, even if the recognition of the control has been forced to positive.

The examples provided in the disclosure ensure that the master key and password never leave the enclave in the RAM. The master key and password, even if encrypted, are never sent to the SPDP and the latter will have no way of calculating them. The master key is not even accessible to the user, since it is the result of a calculation carried out by the security application, and never leaves that security application's enclave. In the two-part KIN and SIN algorithm variant, the private keys for asymmetric encryption of the DE algorithm keys and of the user's signature cannot be calculated without the help of the SPDP. In any case, the SPDP cannot calculate these private keys. Nor does the SPDP have access to the DE algorithm keys used by initialized security applications to exchange data with each other. The routing server RS only has access to unique user numbers to ensure correct data routing, and to the public keys for the ASYE and SASY algorithms of the SPDP and all initialized security applications. All data sent through this server is encrypted, and the RS has no keys to decrypt this data.

In accordance with the present disclosures, a security application for an IT device is provided, said application being designed to:
give a user of the IT device on which said security application is installed access to a set of secure services in which encrypted data is exchanged with other security applications installed on other remote IT devices;
have a secure area of the RAM to which only the security application can have access, the enclave;
be equipped with an initialization process enabling, in particular, the collection of user identification data that never leaves the enclave before being destroyed, and the provision of the keys needed to encrypt the data exchanged;
be equipped with a login process enabling identification data to be checked when the security application is used after initialization, without this identification data leaving the enclave before being destroyed, checking being a prerequisite for the user of the IT device to be able to access the secure services;
calculate a master key from the identification data, first at initialization and then at each conforming login, in a collaborative process with a remote security policy decision point. This master key never leaves the enclave before being destroyed and is essential for the security application to be able to access the encryption keys.

The present disclosure also relates to a security system for IT devices, the security system being designed to:
implement a virtual machine in the RAM of the IT device so that part of the RAM is allocated to the virtual machine, in which the allocated part of the RAM defines a secure area, and so that the virtual machine in turn allocates a part of the RAM to the aforementioned security application, the latter part of the RAM defining an enclave; and
operate this security application on the virtual machine, in which the security application controls access to the enclave.

Advantageously, the security system is designed to:
implement a physical machine that allocates part of the RAM to the security application described above, this allocated part of the RAM defining a secure area, the enclave; and
operate this security application on the physical machine, in which the security application controls access to the enclave.

According to one feature, the enclave is used to store unencrypted data before encryption or after decryption.

The enclave is further used to store encryption keys if these are to be kept confidential, and is also used to implement the security application.

Advantageously, the virtual machine is implemented and comprises drivers for peripheral devices of the IT device, in which the peripheral devices are used to process unencrypted data.

The virtual machine is further implemented and comprises third-party software for processing unencrypted data.

According to one feature, the security application is designed to implement a security policy enforcement point.

The security application is also designed to check that any data entering or leaving the enclave is encrypted and, if necessary, signed in a predetermined way.

Furthermore, an encryption algorithm (DE) has been defined to encrypt confidential data.

More specifically, two asymmetric encryption algorithms have been defined, a first algorithm (ASYE) for encrypting the keys of the DE algorithm or of the initialization data, and a second algorithm (SASY) for signing the encryption of these keys or of these data. Also associated with the asymmetric encryptions are two key pair initialization algorithms (public key, private key), a third algorithm (KIN) for ASYE and a fourth algorithm (SIN) for SASY. The KIN and SIN algorithms can be broken down into two parts, KIN1 and KIN2 for the former, and SIN1 and SIN2 for the latter.

Advantageously, the security application is designed to communicate with a remote security policy decision point (SPDP) via a routing server (RS) under the control of the SPDP, the security application being designed to implement the DE, ASYE, KIN, SASY and SIN algorithms.

The disclosure also relates to a security architecture comprising the previously described security system and remote servers, SPDP and RS, in which each IT device receives a unique user number and the public keys of the SPDP's ASYE and SASY algorithms from the remote server RS.

Advantageously, in this security architecture, the security application initialization process receives a password, pwd, or identification data from a user, which can be condensed into a single piece of data, pwd, then applies a one-way hash function, H, to it, and stores the hash result, H(pwd), in the enclave.

Moreover, in this security architecture, the security application is designed in this case to ensure that an initialization request defined as the encrypted version of the concatenation of a pseudorandom key, M, of a certain bit length, the unique user number, and a value h being the hashed version of the hashed password, wherein h=H(H(pwd)) is sent to the remote SPDP via the RS, in which this concatenation is encrypted using the public encryption key of the SPDP's ASYE algorithm.

Advantageously, in this security architecture, when an initialization request is received from a security application, the SPDP creates a secret value s and stores it together with the value received for h and the unique user number.

This security architecture is further designed to enable the SPDP server to
create initialization data, empty if the KIN and SIN algorithms are not broken down into two parts and otherwise comprising the output data of the KIN1 and SIN1 algorithms; encrypt the concatenated initialization data with the secret value s using symmetric encryption with the M key; and
send the encrypted result to the security application that initiated the request via RS.

Also, in this security architecture, when encrypted initialization data is received, the security application is designed to decrypt the initialization data and the value s with symmetric encryption using the M key and generate the two public-private key pairs of the ASYE and SASY algorithms using a secret value t, unknown to the SPDP, as input to the KIN and SIN algorithms if the initialization data is empty, and this secret value t together with the initialization data as input to the KIN2 and SIN2 algorithms otherwise. The security application is also designed to send the RS the two public keys of the ASYE and SASY algorithms thus calculated.

Advantageously, in this security architecture, the security application calculates a master key based on the secret value s and the hashed version of the password H(pwd).

Specifically, in this security architecture, the master key is calculated according to H(s\hat{ }H(pwd)) and a control C is calculated according to H(s\hat{ }H(s\hat{ }H(pwd))) and stored on a local bulk memory for subsequent reuse wherein H is the one-way hash function, s is the secret value, and \hat{ } is an XOR operation.

Also, in this security architecture, the security application is designed to use the master key to encrypt confidential data and encryption keys of the DE algorithm, for storage on the bulk memory.

Also, in this security architecture, the security application's login process is designed to check the user's identity when a new login is initiated, according to the following process:
receive a login password, Igpwd, from the user;
calculate a hash function, H, of the login password, Igpwd, or the condensed identification data into a single datum Igpwd, H(Igpwd), then calculate a value Igh from a hash function of the result, so that Igh=H(Igpwd));
obtain a pseudorandom value D, of a certain bit length;
calculate a value S, wherein S=H(M\hat{ }Igh); by concatenating the unique user number, and the D, M, and S values;
   encrypt the concatenation with the public key of the ASYE algorithm of the SPDP; and
send the encrypted concatenation to the SPDP as a login request, via the RS.

Moreover, in this security architecture, the SPDP is designed so that when the login request is received, this SPDP can:
decrypt this login request using its private key of the ASYE algorithm;
check the unique user number;
if the unique user number is valid, check that the received value S is equal to S=H(M\hat{ }h);
if S is confirmed, encrypt the secret value s with symmetric encryption using the M key, concatenate it with the result of the encryption of D with the ASYE algorithm using the public key of the security application that initiated the login request, and send this concatenation to that application, or an empty value if one of the checks failed, via RS.

In this security architecture, the security application is also designed to allow, when it receives the concatenation in response to a login request, to:
check that this concatenation actually originates from the SPDP, by checking that the decryption of the second part of the concatenation using its private key from the ASYE algorithm returns the D value;
decrypt the first part of the concatenation using the symmetric algorithm and the M key, the result of this operation being s;
recalculate the master key as equal to H(s\hat{ }H(Igpwd));
check that H(s\hat{ }H(s\hat{ }H(Igpwd))) is indeed equal to the control value C stored during initialization
authorize use of the secure services of the IT device in question if the concatenation is not empty, if it comes from the SPDP and if the control value has been found.

Advantageously, in a security architecture thus equipped with initialization and login processes as described, authorization to access secure services cannot be forced by a change in the code of the security application which would, for example, make the check of the control C always positive. This control is only an indication to the user that the password is correct or not. If the password is incorrect, the calculated value of the master key is necessarily erroneous and the encryption keys of the DE algorithm and the private keys of the ASYE and SASY algorithms cannot be decrypted, making it impossible to use the secure services, even if the recognition of the control has been forced to positive.

In this security architecture, the remote SPDP is also designed to implement the functions of a security policy decision point, comprising a security policy engine and a security policy administrator.

Advantageously, in this security architecture, the remote RS is designed to carry out routing operations by keeping the encrypted data available to the recipients for a certain period of time, keeping the public keys for the ASYE and SASY algorithms of the SPDP and the initialized security applications available to any security application or to the SPDP that requests them, and acting under the control of the SPDP, which can prohibit it from routing certain exchanges pursuant to the security policy.

Throughout the description and claims of this specification, the words “understand” and “contain” and their variations mean “including but not limited to” and are not intended for (and do not exclude) other parts, additives, components, integers or steps. Throughout the description and claims of this specification, the singular includes the plural, unless the context requires otherwise. In particular, when the indefinite article is used, the specification must be understood as envisaging plurality as well as singularity, unless the context requires otherwise.

Features, integers, characteristics, compounds, chemical fragments or groups described in connection with a particular aspect, embodiment or example of the invention are to be understood as applicable to any other aspect, embodiment or example described herein, unless inconsistent therewith. All of the features disclosed in this specification (including the claims, abstract and accompanying drawings), and/or all of the steps of any method or of any process thus disclosed, can be combined in any combination, with the exception of combinations in which at least some of these features and/or steps are mutually exclusive. The invention is not limited to the details of all of the preceding embodiments. The invention extends to any new feature, or any new combination, of the features disclosed in the present specification (including the claims, abstract and accompanying drawings), or to any new feature, or any new combination, of the steps of any method or process thus disclosed.

The reader's attention is directed to all papers and documents which have been contemporaneously or previously filed with this specification in connection with this application and which are open to public inspection with this specification, and the contents of all such papers and documents are incorporated herein by reference.

It is understood that various changes and amendments may be made to the examples described herein without departing from the scope of this disclosure.

### LIST OF REFERENCE NUMBERS

100 security system
102 virtual machine
102b physical machine
104 security application
106 RAM
110 memory module
112 CPU
114 bulk memory
116 communication module
118 information creation and retrieval peripheral
120 virtual machine
122 security application
122a first security application
122b second security application
124 RAM sub-set
126 driver
150 IT device
200 security policy decision point
210 sharing line
202 communication network
204 routing server
250 security architecture
300 security architecture

1. A security application for an IT device, to facilitate encrypted communication, in which the security application is configured to communicate with a remote security policy decision point (SPDP) via a routing server (RS), the security application being configured under the control of the security policy decision point (SPDP) to:
implement an enclave in a random access memory (RAM) of the IT device, the enclave being a secure area exclusively accessible to the security application;
implement an initialization process to collect user identification data;
calculate, from the user identification data in communication with a remote security policy decision point, a master key for use in local encryption;
implement a login process enabling the login identification data to be checked against the user credentials; and
implement a management process to store and process at least the user credentials, the login credentials, the master key, and the encryption keys exclusively within the enclave;
in which security application the IT device receives a unique user number and a public key of a first asymmetric encryption (ASYE) algorithm of the SPDP from the remote routing server (RS); and
this security application is configured to provide the initialization process comprising
generating a value h, wherein h=H(H (pwd)), pwd is a password received from the user, and H is a one-way hash function;
encrypting the unique user number, a pseudorandom M key of a certain bit length, and the value h using the public key; and
sending them to the SPDP via the RS.

2. The security application according to claim 1, in which the unique user number, the pseudorandom M key of a certain bit length, and the value h are concatenated prior to encryption using the public key.

3. The security application according to claim 1, configured to
receive encrypted server initialization data from the SPDP server, and
decrypt the server initialization data by means of the encryption using the (M) key, wherein the server initialization data comprises a first secret value (s).

4. The security application according to claim 3, configured to calculate the master key based on the first secret value (s), and the hashed version of the password H(pwd) wherein H is the one-way hash function.

5. The security application according to claim 4, in which the master key is calculated according to H(s\hat{ }H(pwd)), wherein H is the one-way hash function, s is the first secret value, and \hat{ } is an XOR operation.

6. The security application according to claim 3, in which a control value C is calculated according to H(s\hat{ }H(s\hat{ }H(pwd))) and stored on a local bulk memory for subsequent reuse, wherein H is the one-way hash function, s is the first secret value, and \hat{ } is an XOR operation.

7. The security application according to claim 1, configured to use the master key to encrypt one or more of the confidential data, an encryption key of a data encryption (DE) algorithm, for storage on a bulk memory.

8. The security application according to claim 1, in which the security application login process is configured to check the user's identity whenever there is a new login:
receive a login password (Igpwd) from the user;
calculate a hash function (H) of the login password (Igpwd), H(Igpwd), then calculate a value (Igh) from a hash function of the result, so that Igh=H(Igpwd));
obtain a pseudorandom value (D), of a certain bit length;
calculate a value (S), wherein S=H(M\hat{ }Igh);
encrypt the unique user number and the D, M, and S values with the public key of the asymmetric encryption (ASYE) algorithm of the SPDP; and
send the encrypted data to the security policy decision point (SPDP) as a login request, via the routing server (RS).

9. The security application according to claim 8, in which the unique user number and the D, M, and S values are concatenated prior to encryption.

10. The security application according to claim 8, configured to make it possible, on receipt of the packet in response to a login request, to:
check that this response packet originates from the security policy decision point (SPDP) by checking that the decryption of a second part of the packet using its private key of the first asymmetric encryption (ASYE) algorithm returns the D value;
decrypt the first part of the response packet with the symmetric algorithm and the M key, in order to obtain the first secret value (s);
recalculate the master key as equal to H(s\hat{ }H(Igpwd));
check that H(s\hat{ }H(s\hat{ }H(Igpwd))) is equal to the control value C stored during initialization;
authorize use of the secure services of the IT device if it comes from the security policy decision point (SPDP) and if the control value has been found.

11. The security application according to claim 1, in which the security application is configured to implement the data encryption (DE) algorithm.

12. The security application according to claim 1, configured to use two asymmetric encryption algorithms, a first algorithm (ASYE) to encrypt one or more of the keys of the data algorithm (DE), one or more of the initialization data and a second algorithm (SASY) to sign one or more of the encryptions of these keys or of these data.

13. The security application according to claim 11, configured to use two key pair initialization algorithms, a third key pair initialization (KIN) algorithm associated with the first algorithm (ASYE) and a fourth key pair initialization (SIN) algorithm associated with the second algorithm (SASY).

14. The security application according to claim 12, in which the third and fourth algorithms (KIN; SIN) can be broken down into two parts, (KIN1, KIN2) for the third algorithm, (SIN1, SIN2) for the fourth algorithm.

15. The security application according to claim 11,
configured to
receive encrypted server initialization data from the SPDP server, and
decrypt the server initialization data by means of the encryption using the (M) key, wherein the server initialization data comprises a first secret value (s),
the security application comprising in response to the reception of the encrypted server initialization data from the SPDP server,
the generation of two public-private key pairs of the asymmetric encryption algorithms (ASYE; SASY) using a second secret value (t), unknown to the SPDP with the encrypted server initialization data as input to the key pair initialization algorithms (KIN; SIN); or
the generation of two public-private key pairs of the asymmetric encryption algorithms (ASYE; SASY) using a second secret value (t), as input data if the encrypted server initialization data is empty.

16. The security application according to claim 14, configured to send the two public keys of the asymmetric encryption algorithms (ASYE; SASY) to the routing server (RS).

17. The security application according to claim 1, in which the master key is confined within the enclave.

18. The security application according to claim 1, in which the security application is configured to implement a security policy enforcement point.

19. The security application according to claim 1, configured to be implemented in the enclave.

20. A security architecture comprising a comprising an IT device hosting the security application according to claim 1, the remote security policy decision point (SPDP) server and the remote routing server (RS).

21. The security architecture according to claim 20, in which, when an initialization request is received from a security application, the SPDP creates the first secret value (s), and stores it together with the value received for (h) and the unique user number.

22. The security architecture according to claim 21, in which the SPDP is configured to:
encrypt the initialization data concatenated with the secret value (s) by means of symmetric encryption using the M key; and
send the encrypted result to the security application that initiated the request via the routing server (RS).

23. The security architecture according to claim 20, in which the SPDP is configured to:
create initialization data that is empty if the key pair initialization algorithms (KIN; SIN) are not broken down into two parts, or include the output data of the algorithms (KIN1; SIN1) if they are broken down into two parts.

24. The security architecture according to claim 20, in which the security policy decision point (SPDP) is configured so that when it receives the login request, it performs the following operations:
decrypt the login request using its private key of the asymmetric encryption (ASYE) algorithm;
check the unique user number;
if the unique user number is valid, check that the received value S is equal to S=H(M\hat{ }h); and
and if S is confirmed, encrypt the first secret value (s) by symmetric encryption using the (M) key, concatenate it with the result of the encryption of (D) with the asymmetric encryption (ASYE) algorithm using the public key of the security application originating the login request;
and send the concatenation to the security application via the routing server (RS).

25. The security architecture according to claim 24, in which the SPDP point is configured to send, via the routing server (RS), an empty value if one of the checks has failed.

26. The security architecture according to claim 20, in which the remote SPDP is configured to perform the functions of a security policy decision point, comprising a security policy engine and a security policy administrator.

27. The security architecture according to claim 26, in which the remote routing server (RS) is configured to carry out routing operations by keeping the encrypted data available to recipients for a certain period of time, keeping the public keys of the asymmetric encryption (ASYE; SASY) algorithms of the security policy decision point (SPDP) and of the initialized security applications available to any security application or to the security policy decision point (SPDP) which may require them, and to act under the control of the security policy decision point (SPDP) which can prohibit it from routing certain exchanges pursuant to the security policy.

28. Computer-implemented instructions which, when executed by a processor, prompt the processor to provide the security application according to claim 1.
